(19) United States
(12) Patent Application Publication
(10) Pub. No.: US 2025/0130134 A1
(43) Pub. Date: Apr. 24, 2025

(54) SYSTEM AND METHOD FOR ACOUSTIC LEAK DETECTION IN A UTILITY DISTRIBUTION SYSTEM

(71) Applicant: Kamstrup A/S, Skanderborg (DK)

(72) Inventors: Mick Althoff KRISTENSEN, Skanderborg (DK); Sune Hoveroust DUPONT, Skanderborg (DK); Søren Tønnes NIELSEN, Skanderborg (DK); Peter Schmidt LAURSEN, Skanderborg (DK); Jens Lykke SØRENSEN, Skanderborg (DK)

(73) Assignee: Kamstrup A/S, Skanderborg (DK)

(21) Appl. No.: 18/687,547

(22) PCT Filed: Sep. 6, 2021
(86) PCT No.: PCT/DK2021/050275

§ 371 Date: Feb. 28, 2024

(51) Int. Cl. G01M 3/24; G01M 3/28

(52) U.S. Cl. CPC G01M 3/243; G01M 3/2815

(57) ABSTRACT

A system and a method for identifying a leak indication in a utility distribution system is described. A pipe network for supplying a utility to a multitude of service connections includes a plurality of acoustic sensors mounted at the service connections. The acoustic sensors are preferably integrated in ultrasonic flow meters. The method comprises the steps of obtaining information about a time of change of a fluid pressure and then establishing a first noise indicator from the noise measured by the acoustic sensors before said time of change, establishing a second noise indicator from the noise measured after said time of change; and then correlating one or more first noise indicators and second noise indicators with the fluid pressure to identify service connections subject to leak indications. A leak detection system based on a mathematical cross correlation of noise indicators and fluid pressure in a fluid pipe system is also described.

### FIELD OF THE INVENTION

The present invention relates to a system and methods for identifying leaks in a utility distribution system, such as a water distribution system. The system includes a plurality of acoustic sensors configured to measure noise or an acoustic profile of a pipe network.

### BACKGROUND OF THE INVENTION

In distribution networks for potable water or hot water for district heating it is of utmost importance to be able to detect leaks quickly after they appear. In water distribution networks not only because scarce drinking water may be lost but also because leaks are a possible source of contamination as the water becomes directly exposed to the surroundings. Several systems exist to detect leaks in distribution networks, including acoustic measurement systems (listening sticks, noise correlators, ground microphones, noise logger systems, etc.), trace gas systems, and SAR radar systems. However, only few of these systems focus on continuous monitoring of the network.

Noise loggers (accelerometers or hydrophones) installed on stop valves or fire hydrants are known and combined with correlation techniques these may be used to analyze data and track network developments over time. However, such logger systems require many logger devices to be installed to cover an entire network and get an optimal coverage of the grid. Such standalone systems are expensive, time consuming to install and must be maintained to work properly.

More resent monitoring systems are based on noise measuring being implemented in household smart meters. Such systems benefit from the fact that smart meters are installed at all service connections and installation and maintenance of the meter-based noise logger system becomes an integrated part of installation and maintenance of the consumption meter infrastructure. Furthermore, smart meters are often equipped with wireless communication capabilities that can be shared by the noise logger system.

Consumption meter based noise loggers or acoustic sensors may however suffer from disadvantages because they are influenced by a high level of ambient noise, especially when installed inside a residential house where ambient noise sources such as consumption flow, circulation pumps and flow noise from district heating etc. exists. A need therefore exists for an improved leak detection system based on measurement data from noise loggers or acoustic sensors.

### OBJECT OF THE INVENTION

It is an objective to provide an improved leak detection system and method for detecting leaks in pipe networks, such as utility distribution networks for water and hot water for district heating. Further, it is an objective to provide an improved approach for reducing the impact of ambient noise in a system including acoustic noise detectors or sensors.

### DESCRIPTION OF THE INVENTION

The objective is achieved by a method for identifying leak indication in a utility distribution system including a pipe network for supplying a utility to a multitude of service connections where a plurality of acoustic sensors are mounted at the service connections and where the acoustic sensors measure noise in the pipes. The method is characterized by the following steps:
obtaining information about a time of change of a fluid pressure
establishing a first noise indicator from the noise measured before said time of change
establishing a second noise indicator from the noise measured after said time of change; and
correlating the one or more first noise indicators and second noise indicators with the fluid pressure to identify service connections subject to leak indications.

The invention utilizes the cognition that the fluid pressure in a pipe is mathematically correlated to the noise in a pipe. The correlation value—a coefficient—is used as an expression of the probability that a noise in a pipe originates from a leakage. According to the invention noise indicators are established by the acoustic sensors and a group of first noise indicators belong to a group of noise indicators measured before a fluid pressure is changed in the pipe and a group of second noise indicators belong to a group of noise indicators measured after the fluid pressure has changed. By obtaining or retrieving information about the time the fluid pressure changed a mathematical correlation between the fluid pressure as a first independent variable and the noise indicator as a second dependent variable can be made. According to the invention a method is achieved wherein ambient noise sources, which noise sources do not relate to leakages, are filtered out in a system of acoustic noise sensors included in a utility distribution system. The method is based on the insight that noise originating from leaks or other system abnormalities is correlated with the pressure in the system, whereas noise from most ambient noise sources are not.

The advantage of this method is a high reliability in identifying the service connections that may have a leak. The number of false positives are reduced and unnecessary earthworks avoided. The wording change of fluid pressure is to be understood as a change from one fluid pressure amplitude to another fluid pressure amplitude. One pressure amplitude or level can be the normal fluid pressure such as the standard operating pressure of the distribution system and the different fluid pressure can be the pressure amplitude aimed at due to a planned and controlled decrease or increase in the operating pressure of the distribution system. However, the change of fluid pressure may also be caused by naturally occurring pressure variations in the distribution system.

Once the normal acoustic noise level is determined the pressure in the amended (or abnormal) state of the pipe system is measured, i.e. in a state where the pressure of the fluid in the pipe deviates from the normal pressure. From acoustic noise measurements made in each of these two pressure states the first noise indicator and the second noise indicator are established and a correlation of these two indicators with the fluid pressure makes it possible to make a statement about the presence or not of a leakage in the pipe system. The invention thus utilizes a change in the fluid pressure of the pipe to detect the presence or not of a leakage. The inventive method is preferably implemented at zero flow or low flow in the pipes.

The steps for determining the presence of normal- and changed fluid pressures and establishing first and second noise indicators may be done as separate or integrated steps. For example the first noise indicator may be established at a time of a normal fluid pressure. Similarly the second noise indicator may be established at a time of a changed fluid pressure. Whether the first noise indicator is in fact established at a time of normal fluid pressure may not be determined before after the noise indicator has been recorded. This is done by subsequent correlation or comparison of noise measurements and pressure data relevant to a specific acoustic sensor installed at a service connection. The same applies for the second noise indicator.

The information about the time of change of the fluid pressure is provided as a signal from one or more of the following signal providers: a pressure sensing device in the pipe network, a pressure sensor integrated in the acoustic sensor or a pressure sensor in a pressure controlling device, such as in a pump. The word signal provider is thus to be understood as either a sensor generating an analog or digital signal directly representing the pressure which has been measured, or as a signal or information coming from another source, such as a SCADA system. The pressure measurements include system pressure measurements measured as the input pressure delivered at one or more distribution system inlets, such as the pressure provided by one or more supply pumps of the entire distribution network. Pressure sensors can measure the pressure at many points in the utility distribution system but it is advantageous to measure the pressure of a liquid in the pipe at the point where the pressure is generated in the water works or at a point where a pipe sub-network such as a District Metering Area begins. This has the advantage that a centralized measure of the normal fluid pressure and the changed fluid pressure is obtained which simplifies later correlations and calculations.

Alternatively, or in addition to the above, the pressure measurements can include local pressure measurements measured for an individual installation, such as the pressure at a service connection. Service connections are to be understood as pipes with a smaller diameter and maybe with a reduced fluid pressure when compared to a main pipe originating at the centralized utility provider. The pressure at service connections may be measured by a standalone pressure sensor or a pressure sensor integrated in the acoustic sensor or in a smart meter including the acoustic sensor. Preferably, an acoustic sensor is included in a smart utility meter such as an ultrasonic flow meter, which meter is mounted at a service connection, typically in a residential home, and uses ultrasonic transducers as an acoustic sensor for establishing first noise indicators and second noise indicators.

In an alternative embodiment the information about the time of change of the fluid pressure is provided by a utility provider and the information concerns either the historical, actual or planned time of change of fluid pressure. Or the information may simply be that the fluid pressure has changed. In this embodiment of the invention there is no need for knowing the actual or real amplitude of the fluid pressure which means that the invention can be realized without a pressure sensor. Information about that a fluid pressure change has happened, is changing or will change enables a leak data analysis which can identify pipes subject to leak indications. Knowing that the water works will lower the pressure for the next two hours informs the acoustic sensor or the software in the back-end system that the noise indicators measured during this period were measured during a reduced fluid pressure period. The noise data can then be tagged with such information.

Such tagging can be a time stamping. Each of the first noise indicators and/or second noise indicators are time stamped at the time of measurement, and those first noise indicators or second noise indicators with a time stamp close to the time of change of fluid pressure are selected for correlation. Correspondingly first noise indicators or second noise indicators with time stamps earlier or later than the time stamps of the selected indicators are not selected for correlation. Time stamping of the noise indicators has the advantage that the data analysis can be made off line and later than the leakage event. The data analysis in e.g. the back-end system is performed on time stamped noise data which range hours, days or months back in time and the data analysis can perform the correlation of noise indicators with the fluid pressure because there is information about at which time the fluid pressure changed.

Practical tests have shown that the signal amplitude of the measured noise changes over time. This drifting is caused by different factors such as the hole in the pipe getting bigger or changing its shape or the soil around the hole is eroded away hereby changing the sound conditions. The drifting takes place over weeks or months and causes the correlation between noise indicators and fluid pressure to become inconclusive. It has surprisingly been found by the inventors that the correlation shall not be made over a long time period but rather over a short time period. In this way the problem of drifting noise indicators is eliminated. In practice this is done by introducing a data time window in the series of noise indicators and then data handling, i.e. correlating, each window independently. Thus, only first noise indicators or second noise indicators with a time stamp falling within time limits of the time window are used for the correlation, and the time of change is in-between the time limits.

The time window is in the range of 24 hours to 12 hours, more preferred in the range of 11 hours to 5 hours and most preferred in the range of 4 hours to 0.5 hours. Typically the time window is symmetrical around the time of change of fluid pressure, e.g. with two hours before and two hours after.

The correlation coefficient has in tests proved to be subject to undesired spikes in its numerical value. Correlation coefficients calculated in a number of time windows each day, and so repeated over several days, sometimes give high values caused by random correlations due to natural variations in the amplitude of the noise indicators. In order to suppress these variations an average correlation coefficient is calculated from correlation coefficients calculated in a plurality of time windows. The average correlation coefficient is then used to identify service connections subject to leak indications.

The correlation of first and second noise indicators with the fluid pressure can be done with real fluid pressure data measured over time, such as using absolute pressure data measured by a pressure sensor. More preferred however, is the use of a mathematical step function U(t) which indirectly represents the fluid pressure. The mathematical step function U(t) is used as a substitute for real life fluid pressure data when cross correlating with the first and second noise indicators and is used for modelling the knowledge that there are two fluid pressure amplitudes, namely one before and one after the time of change of fluid pressure. The use of the step function has the advantage of simplifying the calculation of the correlation coefficient and making the correlation independent of real life pressure data.

Filtering out non-leakage related noise from ambient sources having a known noise frequency requires knowledge about the nature of the different noise sources in comparison with the noise generated from a leak. Also, noise sources may change over time, requiring systems to be constantly updated. In this regard it is noted that heavy data analysis in edge devices such as smart consumption meters or acoustic sensors may be disadvantageous as it increases current consumption and therefore reduce the battery lifetime. Therefore, in one preferred embodiment, the steps of receiving and storing of one or more first noise indicators and second noise indicators, obtaining information about a time of change of fluid pressure and then performing the correlation is done in a back-end system. The back-end system can for example be a cloud based data- and calculation server.

On the other hand edge computing of measured data is often advantageous over back-end computing of data as just described above as edge computing reduces data transmissions and thereby reduce power consumption. Thus, in an alternative embodiment establishing the first noise indicator, establishing the second noise indicator, obtaining information about a time of change of fluid pressure and then performing the correlation is done by the acoustic sensor, especially by an ultrasonic flow meter including an acoustic sensor.

Tests have shown that the magnitude of the correlation coefficient of a pipe system depends on many parameters such as pipe material, type of soil, length of pipes and the type of automation used (pumps and valves). In some pipe systems a normal non-leak value may be in the range of 0.2 to 0.3. In other systems it may be higher such as 0.3 to 0.4. A correlation coefficient close to 1 is a strong hint about a possible leakage. Advantageously a threshold can be set individually for a pipe sub-network such that a service connection is identified as subject to leak indications if the correlation coefficient between the fluid pressure and the one or more first noise indicators and the second noise indicators is above a predetermined threshold, preferably above 0.4.

The method according to the invention can in principle be based on fluid pressure differences caused by variations in the consumption such as sudden large draining of fluid. The difference in fluid pressure before and after a change in fluid pressure is, however, only seldom large enough to give a clear correlation coefficient. Therefore a step of actively inducing the change in fluid pressure in the utility distribution system or in a part of the utility distribution system is suggested, such as by operating one or more pressure controlling devices arranged through-out the pipe network. Thus, the changed fluid pressure in the utility distribution system or in a part of the utility distribution system can be actively, i.e. artificially, induced by operating one or more pressure controlling devices arranged through-out the pipe network. Regulating fluid or water pressure in a pipe network of a utility distribution system will change the noise pattern or noise amplitude generated by leaks. Non-leakage related noise from ambient noise sources will on the other hand remain as before the water pressure was regulated. Controlling the water pressure may thus be used to filter away ambient noise sources such as pumps or compressors. Especially, systems wherein noise detection takes place at the service connection inside residential houses will benefit from such approach since such systems often are subject to more ambient noise sources.

The first noise indicator and the second noise indicator in the pipe network are measured by the acoustic sensor at regular time intervals. The sampling is typically done at constant intervals but advantageously the sampling rate (frequency) is increased during a time period of the presence of a changed fluid pressure in the utility distribution system or in a part of the utility distribution system. Thus, during an actively induced pressure increase or decrease in the pipe an increased number of data representing a possible leak noise is acquired for data analysis by the acoustic sensor. In this way a more precise statement about a leak indication can be given.

Preferably the acoustic sensors are included in consumption utility meters having radio communication capability for wireless transmission of the first noise indicator and second noise indicators, such as included in ultrasonic flow meters mounted at the service connections. The consumption meter thus comprises communication means configured to receive commands to adjust a noise sampling rate and/or to transmit noise indicators to a remote location.

Preferably, a large plurality of ultrasonic flow meters, such as in the range of 50 to 10.000 flow meters, establish the noise indicator at a time which is synchronized with the time a pressure controlling device is lowering or increasing the fluid pressure of the pipe network. Such large numbers of ultrasonic flow meters are frequent in densely populated urban areas and the large number of leak noise data enables a well-founded statistical correlation with a high degree of correctness in the estimation of leak indication.

The invention further relates to a leak detection system for identifying leak indication in a utility distribution system which includes a pipe network for supplying a utility to a multitude of service connections. The leak detection system is characterized by comprising:
a plurality of acoustic sensors mounted at the service connections and configured to establish one or more first noise indicators and second noise indictors
a back-end system for receiving the one or more first noise indicators and second noise indicators from the plurality of acoustic sensors
a signal provider providing a signal to the back-end system about a change in fluid pressure
wherein said back-end system is configured for correlating the fluid pressure with the one or more first noise indicators established before the change in fluid pressure and the one or more second noise indicators established after the change in fluid pressure in order to identify service connections subject to leak indications.

In its simplest form the signal from the signal provider is an ON or OFF signal informing the back-end system about a change of fluid pressure. Thus, in principle no information about the time of change of fluid pressure is needed. Also, knowledge about the fluid pressure level before and after the change is not needed for implementing the leak detection system. In an alternative embodiment, however, the signal informing about the change in fluid pressure is provided with a time stamp.

Preferably the signal about a change in fluid pressure provided by the signal provider to the back-end system is one or more of the following: an absolute fluid pressure, a relative fluid pressure, a binary signal such as a step function, or a past, actual or future time instant of fluid pressure change, such as a planned change in fluid pressure implemented by a SCADA system.

The leak detection system comprises one or more pressure controlling devices in the pipe network and preferably changes the fluid pressure in order to enable the measurement by the acoustic sensors of first noise indicators and second noise indicators. By having pumps inducing a detectable change in pressure the identification of leak indications is improved.

The pressure controlling devices are preferably variable speed regulated pumps which are in direct or indirect communication with one or more of the acoustic sensors and with the head-end system and where the pump(s) reduces the pressure in the pipe network or stops pumping if an indication of leakage has been established. In one variant of this solution the invention can advantageously be implemented by letting the acoustic sensors transfer the noise indicators themselves, i.e. signals indicative of noise levels, to a back end system which processes the data according to the invention. From the back-end system instructions are then given to the speed controlled pump or to a control system controlling the pump to reduce the pressure or stop pumping all together if an indication of leakage has been established. This is an indirect communication between pump and acoustic sensors.

In another variant of this solution the pump is in direct contact with the acoustic sensor and collects the incoming noise indicators (whether raw or un-processed noise indicators) and processes them by use of its data processing device. A signal indicative of the fluid pressure in the pipe can come from an external pressure sensor but a pressure sensor is often integrated in the pump. After processing the data the pump locally, i.e. by itself, takes the decision to reduce the fluid pressure in the pipe or stop pumping if receiving, calculating or identifying an indication of a leakage. Electronically speed regulated pumps have either integrated memory and control electronics that will be able to process a method according to the invention locally, or memory and control electronics in a PLC or a standalone frequency converter connected to and speed controlling the pump will be able to do it.

Preferably, the acoustic sensors are integrated as a part of an ultrasonic flow meter, the ultrasonic flow meter adds a time stamp to the one or more first noise indicators and second noise indicators and transmits the time stamped indicators by radio communication through a data collection system to the back-end system.

In the preceding text the inventive method and system for acoustic leak detection has been described. The following text describes further advantageous embodiments of the invention applicable to both the inventive method and system. Throughout the specification of the current invention the notion of a pipe network is used. The pipe network may mean the entire pipe network of a utility distribution system or only a section or part of the pipe network of a utility distribution system, which is also sometimes referred to as a pipe sub-network.

In one embodiment a pressure regulation profile or successive changes in pressure may be applied to the entire pipe network or only a part of it. The pressure regulation profile, i.e. knowledge about the changing fluid pressure, may then be correlated with noise indicators to look for correlations and identify leak indications or indications about the presence of other abnormalities.

Such a pressure profile or pressure variations could be implemented during night time to minimize the inconvenience experienced by consumers. However, the pressure variations do not need to be out of the range of normal system operation. Also, the pressure variations or pressure profile correlated with established noise indicators may be naturally occurring pressure variations occurring in the pipe network.

In one embodiment variations in system fluid pressure may be within a range of 75% to 125% of the normal operation fluid pressure. However in some implementations of the method and system, larger variations such as 50%-150% or 25-175% or 0-200% may be applied to further improve filtering away ambient noise sources, i.e. sources not relating to leakages.

Furthermore, the same or different pressure variation profile could be implemented at regular intervals, such as each night, over a period of time, such as during the course of a week, a month or a year to filter out fluctuations in both ambient noise sources and leak variations. A pressure variation profile may also be implemented continuously in order to implement ongoing monitoring of a pipe network. All in all this will improve the probability of determining whether detected noise is caused by an irrelevant ambient noise source or in fact originates from a leak or other abnormality.

In a further embodiment of the invention the pressure variation profile may have different shapes. During the time period with changed fluid pressure, i.e. the period where the fluid pressure is above or below the normal fluid pressure and where an acoustic noise indicator has changed its value (such as amplitude) compared to its value during the normal fluid pressure, the pressure can be held at a constant amplitude or have a variable amplitude. For example, in order to avoid water hammer, S curves or linear ramping up or down of the pressure amplitude can be used. The pressure variation profile can also be a pulsed profile with a number of pulsations during the time period of the changed fluid pressure.

In an embodiment of the invention a pipe system or pipe sub-system including a plurality of acoustic sensors uses a method where a noise threshold is applied to all acoustic sensors such that those acoustic sensors/installations which have an abnormal noise level/second noise indicator can be identified and subjected to further analysis. The leak noise threshold is applied in a data analysis of the noise indicators and if the noise indicators are below the leak noise threshold the data are removed from the data group being analyzed or are disregarded in the analysis. In a special embodiment the noise threshold is implemented as a programmable threshold in a leakage monitoring software as used in graphical computerized monitoring systems by service technicians in central utility distribution works. The service technician can adjust the noise threshold in the software and hereby filter away noise indicators found irrelevant by the technician. The noise threshold can be a global value, determined based on noise indicators from all acoustic sensors in a pipe system. The noise threshold could also be based on noise indicators from a percentage of the sensor population such as 90%, disregarding the sensors representing the 10% highest and/or lowest noise indicators. The noise threshold can also be determined in more advanced ways based on statistical parameters of the actual noise indicators in the population, such as the minimum, maximum, mean, standard deviation or higher order moments. The noise threshold could also be set based on experience and measurements from different pipe systems gathered over time.

In another embodiment of the invention for determining service connections subject to leak indications, the step of correlating first noise indicators, second noise indicators and fluid pressure measurements includes correlating data from the acoustic sensors above the noise threshold only. Only these acoustic sensors may then be included in the analysis during the pressure variation, and data collection may in some embodiments be limited to these acoustic sensors.

In another embodiment a part of the correlation process may include determining changes in noise indicators during pressure variations. A change in the noise indicator above a predetermined level, such from 20% to 50% or more during the pressure variations may be a good indication that the noise power is due to a leak in the pipe system. A noise indicator may thus be considered to have changed if the level of the difference between the first noise indicator and the second noise indicator is more than 20%, i.e. if the noise indicator varies more than 20% during pressure variations in the pipe system or sub-system. The percentage change in noise indicator required to determine a noise indicator change may also be set as a percentage related to the change in pressure.

Also, to improve the analysis the statistical behavior of the noise indicator at a specific service connection may be taken into account. Especially the standard deviation may be relevant. In this way the significance of the change in a noise indicator can be evaluated.

In another more calculation heavy embodiment the step of correlating first noise indicators, second noise indicators and fluid pressure measurements is carried out without the application of the noise threshold. In this embodiment data from acoustic sensors at all or substantially all service connections may be evaluated for changes during the pressure change. Here again the same percentages as mentioned in relation to the other embodiments may be applied to determine a noise indicator change.

Furthermore, the correlation step may include analysis in the frequency domain. As an alternative or supplement to the noise threshold, a frequency threshold may be applied. For example frequency peaks in the frequency spectrum below 100 Hz may be monitored and if these change 5%, 10% or more it indicates that the noise is due to a leak.

### DESCRIPTION OF THE DRAWINGS

In the following embodiments of the invention will be described with reference to the figures:

FIG. 1 illustrates a utility distribution system including a pipe network,

FIG. 2 illustrates a pipe sub-network of a utility distribution system,

FIG. 3 illustrates a method for determining leak indications,

FIG. 4 illustrates a communication infrastructure for a utility distribution system,

FIG. 5 illustrates an acoustic sensor for installation at a service connection,

FIG. 6 illustrates a pressure regulation profile and acoustic sensor sampling times,

FIG. 7 illustrates naturally occurring system pressure variations,

FIGS. 8a and 8b illustrate examples of leak noise power as a function of system pressure,

FIG. 9 illustrates different scenarios of a utility distribution system subject to varying pressures profiles,

FIG. 10 illustrates noise indicators measured before and after a change in fluid pressure

FIG. 11 illustrates noise indicators measured before and after a change in fluid pressure

FIG. 12 illustrates over one week correlation coefficients determined according to the invention

FIG. 13 illustrates the averaged correlation coefficients of FIG. 12

### DETAILED DESCRIPTION OF THE INVENTION

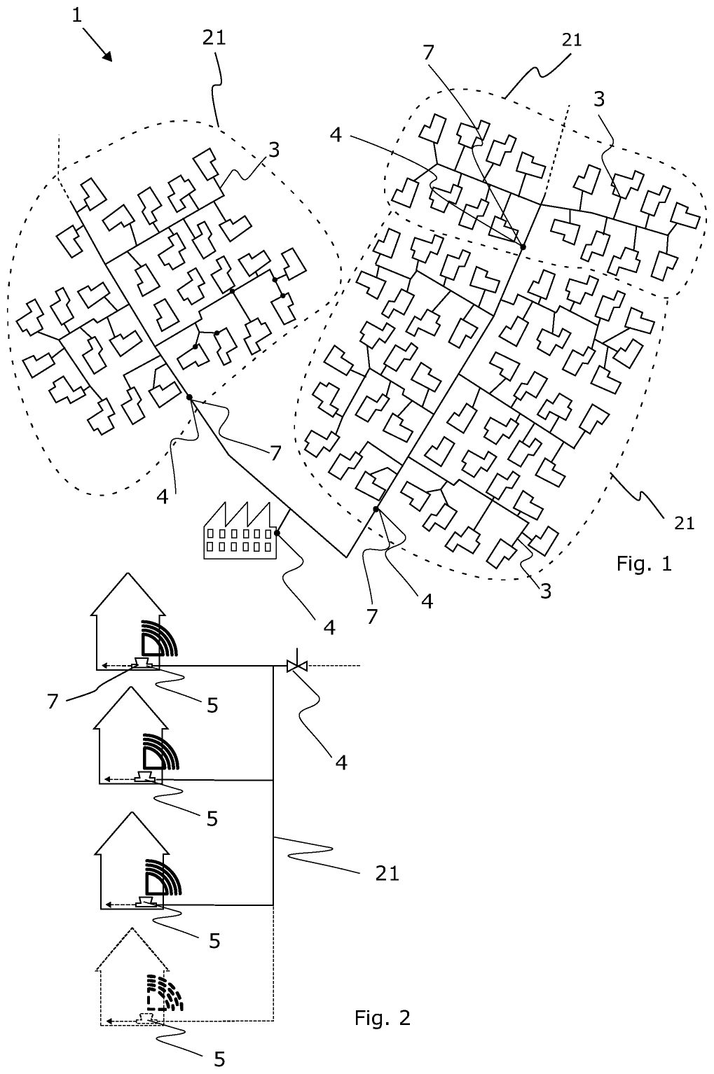

FIG. 1 illustrates a utility distribution system 1 including a pipe network and a plurality of service connections 3. The utility distribution system and pipe network may for example be a system for distributing potable water or heated water in a district heat system. The service connections 3 supply residential, commercial or other premises with the respective utility. The pipe network may be divided into a number of pipe sub-networks 21, however this may vary from distribution system to distribution system.

The distribution system shown includes a number of pressure controlling devices 4 arranged through-out the pipe network. Depending on the particulars of a distribution system, including system size and topology, one or more pressure controlling devices may be included. Examples of pressure controlling devices are pumps, pressure reducing control valves or pressure sustaining valves and the devices are provided in order to ensure that the right pressure is delivered at the service connections. The pressure controlling devices may both be used to control the pressure in the entire pipe network or to control pressure in a pipe sub-network, often referred to as a district metering area (DMA). In one implementation sub-pipe network may be pressure maintained by a pump.

The distribution system further includes a plurality of acoustic sensors 5 (shown in FIG. 2), such as stand-alone smart acoustic sensors or acoustic sensors implemented in smart consumption meters, provided at service connections throughout the system. The acoustic sensor may be provided at all service connections or only at a limited number of the service connections. In case the acoustic sensor is implemented in a smart consumption meter the meter may be installed to measure consumption of the utility supplied through the service connection. The notion of an acoustic sensor is used throughout the specification to mean both a stand-alone smart acoustic sensor or an acoustic sensor implemented in smart consumption meters. By a smart acoustic sensor or consumption meter is meant a device including means providing computing power and/or communication means for communicating data to and from external devices either wirelessly or via wired connections.

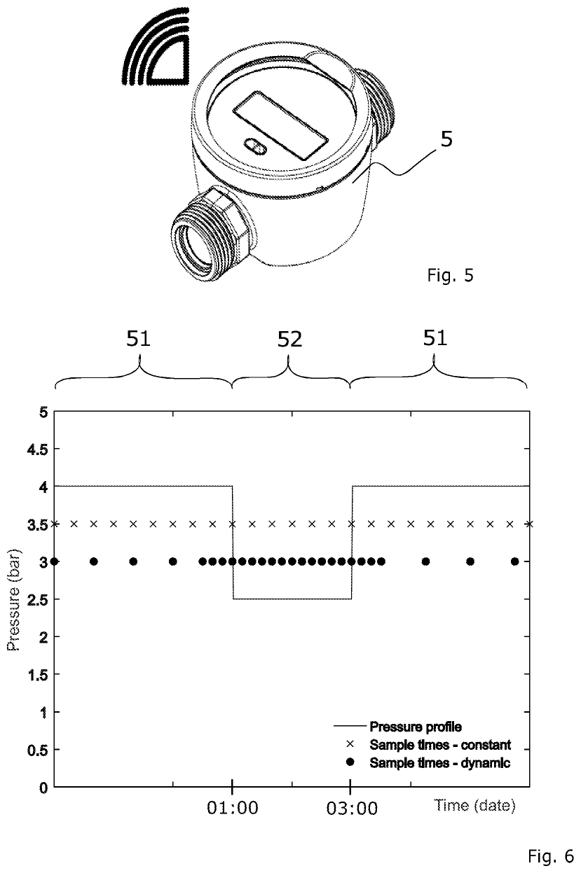

Referring to FIG. 5, an exemplary embodiment of an implementation of an acoustic sensor 5 is shown. The acoustic sensor 5 is adapted for being connected to the pipe network or pipe sub-network 21 and is configured to measure noise or acoustic signals from the fluid flow in the pipe network. Based on the measurements of noise the acoustic sensor is configured to establish noise indicators, also referred to as first noise indicators and second noise indicators as will be further described below. The noise indicators may be established by a processing unit in the acoustic sensor or in a processing unit in a smart consumption meter in which the sensor is included. If the acoustic sensor is an integrated part of a smart consumption meter, a common processing unit—also used to determine flow and consumption by the consumption meter—may also be used to establish the noise indicators.

The noise indicator established may comprise one or multiple values determined by the acoustic sensor. The acoustic sensor may be a dedicated acoustic sensor, such as a transducer including a piezoelectric element, or it may be based on another sensor technology known in the art, such as being a capacitive sensor, an inductive sensor, an optical sensor, or a piezo-resistive sensor, such as a piezoresistive strain gauge. The acoustic sensor may also be a transducer including a piezoelectric element that is also used for ultrasonic flow measurements, for example according to a time-of-flight principle.

Measuring noise or the acoustic profile using a dedicated acoustic sensor or a transducer used for ultrasonic flow measurements is further described in the earlier published patent application by the applicant, International publication number WO 2017/005687 which is hereby incorporated by reference.

The output from the acoustic sensor is one or more electrical signals, either analog or digital. To suppress undesired frequencies (such as the mains frequency) or focus on a specific frequency band, like 10-1000 Hz, analog electrical signals from the acoustic sensor may be electronically filtered. These electronic filters may be high pass filters, low pass filters, notch filters, comb filters and band pass filters. The electronical filters may be simple first order RC filters or cascaded versions of such. Higher order filter types like LCR may also be used. Following the initial electronic filtering, analog evaluation components like peak-detectors, RMS detectors or switchable filters may be implemented resulting in one or a plurality of values indicative of the noise.

Following electronic filtering and analog evaluation, the signal may be digitized using an analog-to-digital converter (ADC) with a bandwidth chosen to match the bandwidth of the electronic filtering. Alternatively, the analog signal may also be converted from analog to digital without electronic filtering and analog evaluation.

In one embodiment the bandwidth of the ADC is 2 kHz but other bandwidths, such as 200 Hz-5 kHz may be applied. The overall sampling period may range from approximately 100 milliseconds (ms) to 1 second or more. In one embodiment the sampling period is approximately 250 ms resulting in a frequency resolution of 4 Hz when the ADC bandwidth is 2 kHz.

A noise indicator may be raw sampled data, i.e. the data are sent as noise indicators from the acoustic sensor to a remote receiver without any data processing made by the sensor. A noise indicator can also be an indicator based on a plurality of other noise indicators, thus grouped into one single indicator, with or without a time stamp. It is preferred however, that a reduction of the number of data in the noise indicator is done through digital data processing of the converted output from the acoustic sensor. It may specifically be a simple maximum or a root-mean-square (RMS) calculation to provide a value representing a measure of the overall noise level. E.g. in a selected frequency band, such as 10-1000 Hz.

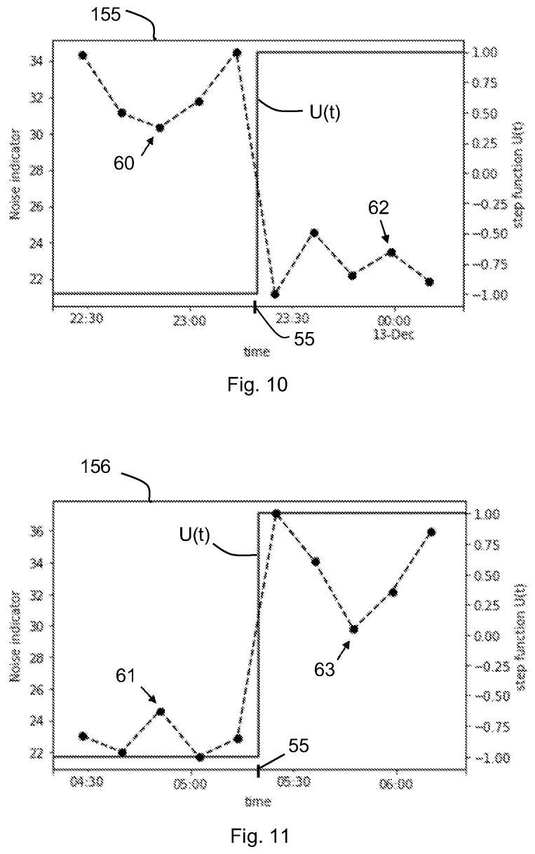

In another example the noise indicators (as shown with 60 and 62 in FIG. 10) may be the result of a statistical analysis of the raw sampled data including the mean, standard deviation and higher order moments. More sophisticated analysis could also establish the noise indicator through frequency filtering into certain frequency bands, followed by an RMS calculation, to provide a range of noise figures associated with different frequency bands. Frequency filtering may also be introduced in order to remove unwanted known frequencies like the mains frequency.

Furthermore, a full Fast Fourier Transform (FFT) may be performed to provide a full spectrum of acoustic signals, involving noise power density as well as associated phase information. The latter level of analysis may be desirable in order to perform a cross correlation calculation with the purpose of triangulating the location of the noise source. However, for many practical purposes the information coming from the simpler noise figure calculations suffices to indicate the position of the noise source.

Throughout all the above described methods for generating first and second noise indicators 60, 62 digital filtering may be applied. Non-limiting examples are FIR filters and IIR filters. The filter characteristic could be high pass filters, low pass filters, notch filters, comb filters and band pass filters. Known undesired frequencies, such as the grid frequency, could also be suppressed in this way.

Also, to create more historical knowledge a long-time-evaluated historic noise measure may be generated from multiple noise indicators created by the acoustic sensor over time. The period between sampling and creating each noise indicator may be substantially longer than the time involved in creating a single noise indicator. Such historic noise measure may be a single value indicative of an average-type noise indicator, i.e. noise level.

Furthermore, the acoustic sensor may be arranged to calculate a plurality of spectral values indicative of respective spectral components of average noise level, e.g. corresponding to selected frequency bands like 1/1 octave or ⅓ octave levels etc. going towards the full frequency spectrum.

The acoustic sensor may also be arranged to calculate a peak value indicative of a peak noise level for a period of time. In addition, the acoustic sensor may be arranged to calculate a plurality of different values indicative of the noise level for the period of time, these could be statistical parameters such as the mean, RMS-value, the standard deviation or higher order moments. By measuring over a period of time and processing the measured signals in the acoustic sensor, it is possible to reduce the amount of data to be communicated from the acoustic sensor to for example a back-end system.

Hereby both long-time-evaluated historic noise measure/level (calculated from multiple noise indicators acquired over a distribution of time) and/or instantaneous noise indicators (only a single noise indicator) may be provided, the main difference being the time scale involved in producing these numbers.

Again referring to FIG. 5, the acoustic sensor 5 further comprises wired or wireless communication means configured to transmit and receive signals, such as activation signals or commands, information, data, such as noise indicators 60, 62 etc. to and from a remote location.

To collect the noise indicators transmitted by the acoustic sensors and possibly also pressure data from the pressure sensing devices, the utility distribution system includes a data collection system 8, such as an automatic meter reading system (AMR) or an advanced meter infrastructure (AMI), as illustrated in FIG. 4. Noise indicators and other information, such as consumption data from an integrated smart consumption meter and acoustic sensor, is transmitted from the acoustic sensor 5 to a back-end system 6 for further processing. The back-end system may be implemented in a number of ways as envisaged by the skilled person, for example as a cloud service or at server facilities located at the utility providers or at a service provider. The back-end system includes a data processing device which by example can be a PLC or a PC work station. Transmission of the noise indicators and possible other information may be effectuated through mobile reading devices 101 for collecting transmissions from acoustic sensors (AMR) or through an installed infrastructure 200 (AMI) for collecting and forwarding the information to the back-end system 6.

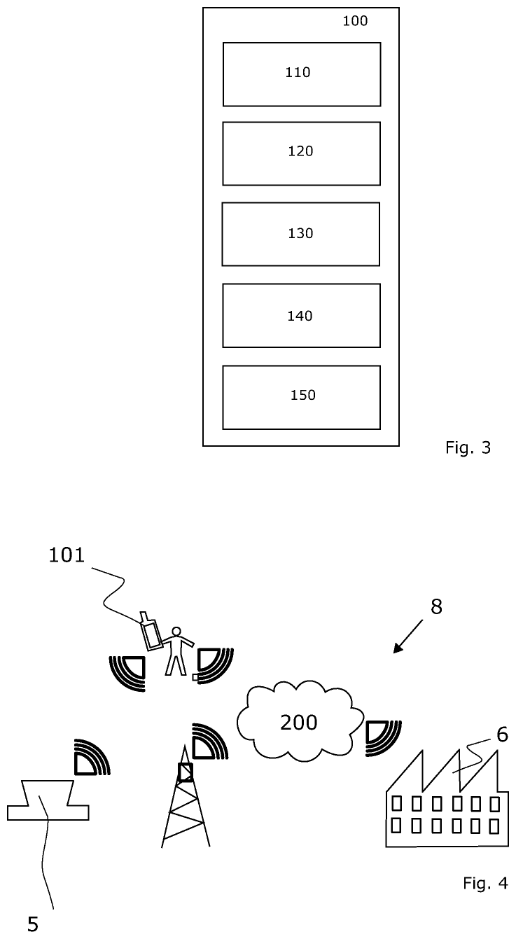

Referring now to FIG. 3, a method 100 for identifying leak indications in the above described utility distribution system will be described. The method includes the step of determining the presence of a normal fluid pressure 110 in the pipe network. The normal fluid pressure may be the standard operating pressure of the distribution system and determination of the normal fluid pressure may include recording the time of the presence of the normal fluid pressure. The method also includes a step of determining the presence of a changed fluid pressure 130, including the recording of the time of the presence of the changed fluid pressure.

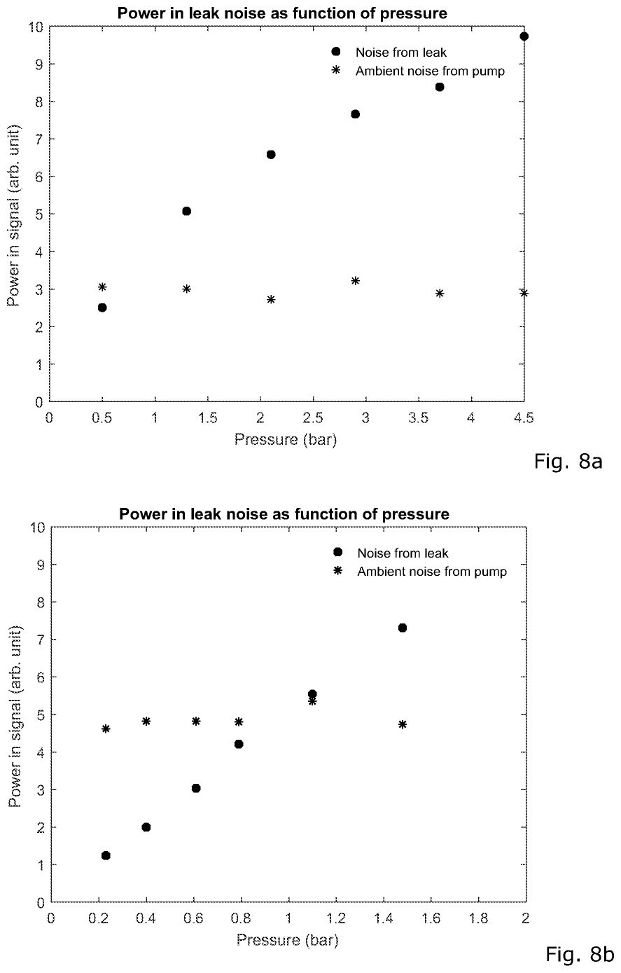

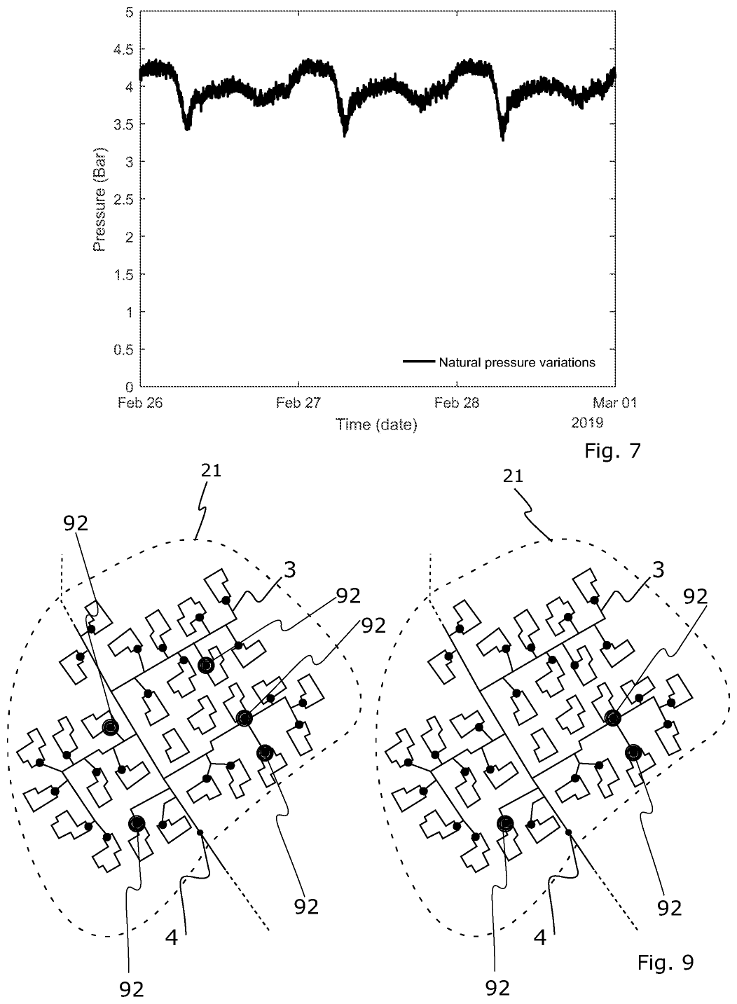

The determination of normal and changed fluid pressure may be part of a continuous monitoring process tracking the development of the pressure in the distribution system. A time series of naturally occurring pressure data for a distribution system is shown in FIG. 7. However, the pressure in a utility distribution system may also be artificially (i.e. actively) controlled. In such a situation the normal fluid pressure may be the standard operating pressure of the distribution system and the changed fluid pressure may be caused by a planned and controlled decrease or increase in the operating pressure of the distribution system.

The changed fluid pressure is advantageously obtained by way of variable speed pumps, for example centrifugal pumps. These pumps have integrated control electronics or external controllers regulating their rotational speed and hence regulating the volumetric displacement of fluid in the pipes. Due to software control of the pumps elaborate pressure profiles in the pipes can be implemented for use in the invention. A wireless or wired communication link directly between the acoustic sensors and the pumps enables an adaptive and automated leakage detection and also a fast reaction to big leakages—the pump can stop pressurizing the pipe system immediately. Alternatively, instead of the direct communication link, the pumps can be controlled from the back-end system 6 (FIG. 4).

Pressure controlling devices 4, as previously mentioned, may be controlled to generate the required fluid pressure changes for the leak identification method. Hereby the normal and/or changed pressure may be artificially induced in utility distribution system. In fact, the pressure may already be reduced by water utilities as part of the daily operation of a distribution system. The pressure in the distribution system may for example be reduced during night time to save costs related to pump operation. In one implementation of the system, a pipe sub-network 21 such as a district metering area, may be pressure maintained by a pump. During night time from for example 01:00-03:00 the pressure is lowered from 4 bar to 2.5 bar. However, the pressure variations may not only be limited to a few hours, pressure variations could also be implemented over days.

FIG. 6 illustrates another time series of pressure data for a distribution system (unbroken line). As seen the fluid pressure in the distribution system or pipe sub-network is at 4 bar until for example 01:00. This represents a time period 51 with a normal fluid pressure. At 01:00 o'clock the pressure is reduced to 2.5 bar thus initiating a period 52 with a changed (reduced) fluid pressure before being raised again to 4 bar at 03:00. The times 01:00 and 03:00 represent respectively a time of change of fluid pressure in the pipe. To be able to use such induced pressure variation as part of the leak identification method, acoustic sensors must in step 140 (FIG. 3) perform at least one and preferably more leak noise measurements during the time of the difference fluid pressure i.e. during the period the pressure is reduced to 2.5 bar in the specific example. As envisaged by the skilled person other distribution system pressures may also be induced. The step of establishing the second noise indicator during the period of reduced fluid pressure may be achieved using a number of different sampling strategies. FIG. 6 illustrates two different strategies. One being obtaining acoustic data at a fixed frequency (illustrated by crosses) with a constant period of time between each measurement. Another is a dynamic strategy (illustrated by black dots) wherein the measurement of acoustic data are established with a varying frequency such that the frequency is higher during the period of difference fluid pressure. As the pressure is only reduced for a limited period of time, increasing the frequency ensures that more data points are collected to improve the data foundation. During the relative longer period of higher or normal fluid pressure the acoustic sensors must in step 120 (FIG. 3) perform at least one and preferably more measurements to establish a noise indicator during the period 51 of normal fluid pressure, which also can be perceived as a baseline for the noise indicator. The sampling frequency during the normal fluid pressure situation can be lower as more time is available to establish these data.

The leak identification method thus includes the steps of establishing first noise indicators 120 at times of normal fluid pressure and acts of establishing second noise indicators 140 at times of changed fluid pressure. As stated above, to be able to determine normal and second noise indicators, the leak identification method also includes the step of determining a normal fluid pressure and difference fluid pressure and/or a change in fluid pressure. The step of determining a normal fluid pressure and changed fluid pressure and/or a change in fluid pressure may be done in each or some of the acoustic sensors or on system level as part of data processing in the back-end system.

The absolute pressure in the pipes does not necessarily need to be known, only knowledge about changes in pressure are required to establish periods of normal and difference fluid pressure. In an implementation wherein natural pressure variation are relied upon for the leak identification method, the changes in fluid pressure on a relative scale must be monitored. Such information could be obtained by including one or more pressure sensing devices 7 in the distribution system. It is also necessary to track which pressure state a noise indicator corresponds to, i.e. whether a noise indicator is established during a period of normal fluid pressure or during a period of changed fluid pressure. To achieve this noise indicators may be time stamped by the acoustic sensor and compared to pressure data collected from the pressure sensing devices monitoring the distribution system. In another embodiment the acoustic sensor or smart consumption meter with integrated acoustic sensor may be provided with a pressure sensing device, where by at least a relative pressure can be recorded for each noise indicator established.

If the first noise indicator is to be established using a dynamic sampling rate as illustrated by the dots in FIG. 6, it is necessary to be able to time the increase in sampling frequency with the time of the artificially induced pressure reduction. To achieve this, one embodiment of the acoustic sensor is provided with 2-way wireless radio communication means whereby a request or command may be transmitted to the acoustic sensor to increase the sampling frequency.

The sampling strategy applied by the acoustic sensor may also be adapted according to the communication capabilities of the acoustic sensor and the available communication infrastructure. If the acoustic sensor and/or communication infrastructure is only configured to allow transmission of data from the acoustic sensor, but no data or commands to be transmitted to the acoustic sensor, a predefined sampling profile must be applied. Such sampling profile could be based on a constant frequency or a dynamic frequency where the sampling frequency is increased in specific time periods, such as during night time or on specific weekdays as illustrated in FIG. 6.

Also, the acoustic sensor may include a short range optical communication device providing an interface for changing the sampling strategy locally. Acoustic sensors including 2-way wireless radio communication means could change sampling strategy on demand from a back-end system. When the pressure profile is planned all acoustic sensors are informed over the 2-way communication link to change their sampling strategies in accordance with the change of the pressure profile (illustrated by the dots in FIG. 6). The sampled data can then either be transmitted live or be stored locally. If the data is stored locally it can be send to a back-end system in one or more larger data packages. Alternatively, data processing including various calculations can be done by the acoustic sensor based on information about the respective pressure profile applied during sampling of the processed data. Subsequently, the acoustic sensor may send the results of the data processing, such as one or more statistical variables, to the back-end system.

Further, acoustic indicators established by an acoustic sensor can be send continuously to the back-end system or stored locally and send to the back-end system in data packages containing multiple measurements.

As mentioned above it is advantageous if the sampling frequency of obtaining noise indicators is higher or at least comparable to the frequency in pressure variations, such that at least one noise indicator is obtained for each level of pressure. However, a lower sampling frequency may also be implemented if the same changes in pressure, i.e. the same pressure profile, are implemented multiple times and possibly combined with dithering of the sampling time or times of establishing noise indicators.

Referring to FIGS. 8a and 8b, an example of a relation between the development in noise power and pipe network pressure or pipe sub-network pressure is illustrated. Each of the charts plot noise measurements representing noise power resulting from a system leak and an ambient noise power originating from a pump against system pressure, i.e. the pressure in the fluid pipes. The vertical axis show the power of the noise signal, here shown in arbitrary units. FIGS. 8a and 8b show noise measurements from two different installations, but the tendency of increased noise, i.e. noise power generated from a system leak as a function of a pressure increase, is the same (black dots in the figures). The ambient noise power shown with asterisks is relatively constant and not affected by the increase in pressure. This suggests that noise power from pipe network- or pipe sub-network leaks may be extracted by considering noise power at varying pressure levels and correlating the measurements.

In this regard it is noted that pressure changes may change both the total radiated noise power of a leak and but also the frequency of the radiated noise. Therefore, both the changes in noise power and the changes in the frequency composition of the noise may be determined and analyzed. However, the strongest correlation is often seen with respect to total radiated power and to a less degree frequency changes. Therefore, pressure variations in the pipe network or sub-network allows for the implementation of a more simple data analysis, such as an RMS value, into the acoustic sensor since it will be possible to detect the influence of the pressure change on the noise power and thus the noise indicators. Simpler data analysis is advantageous in the acoustic sensor since it reduces the need for processing power and thus lowers power consumption and improves sensor battery lifetime.

Referring again to FIG. 3, first noise indicators, second noise indicators and fluid pressure measurements are correlated in step 150 to determine service connections subject to leak indications. Noise measurements and pressure data may be processed by the acoustic sensor it-self or on system level in the back-end system to perform the correlation 150 and leak indication identification.

As described above, the noise power registered by the acoustic sensor when subject to higher pressure, will usually be higher compared to when the acoustic sensor is subject to lower pressure. However, this may not always be the case. In terms of identifying leak indications by correlation of noise and pressure information, the most interesting thing is whether the noise indicators representing the noise power varies with varying pressure.

FIGS. 10 and 11 illustrate an example of noise indicators established while a water work is lowering the fluid pressure during night time. Such lowering of fluid pressure is pre-programmed into e.g. a SCADA system and is repeated every night. As the fluid pressure reduction is the same every night the amplitude of the noise indicators measured by the acoustic sensors would be expected to be the same from night to night. Tests have shown, however, that this is not the case. In a test over 6 days the noise indicators measured at the same point in time each night differed markedly, some noise indicators having a value of “25”, others “50” or “40”, i.e. deviations of more than 100%. This drifting of data values makes it difficult to make a direct correlation between the noise indicators and the change in fluid pressure. The solution is to normalize the data which is done by analyzing the noise indicators in time windows having a limited time span and correlate the noise indicators inside each window with the fluid pressure.

In FIG. 10 the fluid pressure is lowered around 23.20 o'clock and in FIG. 11 the end of the pressure reduction for the night is shown at 05.20 o'clock where the fluid pressure is set back to normal. Studying FIG. 10 in more detail it illustrates first noise indicators 60 measured during a time period of normal fluid pressure (left part of the window) and second noise indicators 62 measured during a time period of lowered fluid pressure (right part of the window). The acoustic sensor measures continuously the noise and establishes noise indicators 60, 62 which in this embodiment are sent to the back-end system 6. The back-end system has from a signal provider got the information about which time the pressure in the pipe changed. The signal provider is a pressure sensor giving a direct analog pressure signal or e.g. a PLC creating an indirect signal based on an expected pressure behavior of the fluid in the pipe—e.g. a SCADA system may have a pre-programmed pressure controlling algorithm with clear indications of what time the fluid pressure will be changed. According to the inventive method the software of the back-end system 6 selects data in the form of first and second noise indicators 60, 62 placed inside a time window 155. The window is placed around the time of change of pressure 55, in this example just before 23.30. The window spans in this example over two hours, but the span can be larger or smaller. Instead of applying information about the real fluid pressure the change in fluid pressure is simulated by applying a mathematical unity step function U(t) to the first and second noise indicators and the function is shown in FIG. 10 with the value −1 and +1. The time window has a span of one hour in the period just before the change in fluid pressure and a period of one hour after the change, i.e. one hour where leak noise indicators are measured during lowered pressure and one hour where normal noise indicators (baseline noise indicators) are measured during normal fluid pressure. In each of the two sections of the window 155 five samples are taken by the acoustic sensor and the first noise indicators sampled have a value ranging from around “34” to around “22” whereas the second noise indicators 62 range from around “22” to “24”, i.e. considerably lower. Thus the time window 155, which has a delimited span, is placed around the time of change 55 of fluid pressure and the first noise indicators 60 measured during normal fluid pressure and the second noise indicators 62 measured during the reduction in fluid pressure are correlated with the change in fluid pressure, in this embodiment represented by a unity step function U(t).

The same considerations apply in FIG. 11 which shows the situation in the morning at the end of the fluid pressure reduction. At 05.20 o'clock the fluid pressure is again increased hereby ending the night saving procedure. The increase in fluid pressure is represented by the unity step function U(t) and first noise indicators 61 represent the noise before the time of change 55 of fluid pressure and second noise indicators 63 represent the situation afterwards. Time delimited window 156 is placed symmetrically around the time of change.

The correlation coefficient calculated from the values in FIG. 10 is C=−0.96 and in FIG. 11 C=0.94 which means there is an evident statistical relation between the two variables noise indicators and change in fluid pressure. On the contrary if the correlation C is low or even close to zero this would have indicated a small or no relation between the two variables.

By using delimited time windows 155 and 156 to capture and select the noise indicators to be correlated a better correlation is achieved. If the number of noise indicators is too big and spanning too long a time period inconclusive results is the consequence as tests showed. Therefore the correlation coefficient is calculated individually for each a plurality of delimited windows i.e. one correlation coefficient for window 155 and another for window 156.

The noise in the fluid is sampled at discrete times in a number of N measurements. N is the total number of samples inside e.g. window 155 and the signal S(t) representing the discrete noise indicators can be written as:

$$S ( t ) \to \{ {s}_{1} , {s}_{2} , … , {s}_{N - 1} , {s}_{N} \}$$

The unity step function U(t), which is used as a representation of a change in fluid pressure, is written as:

$$U ( t ) \to {u}_{i} = \{ \begin{matrix}- 1 & i \leq N / 2 \\ + 1 & i > N / 2\end{matrix}$$

The correlation coefficient between S(t) and U(t) can be calculated based on Pearson's correlation coefficient:

$$C = \frac{Cov ( S ( t ) , U ( t ) )}{{σ}_{S} {σ}_{U}}$$

where C is the correlation coefficient, Cov(S(t), U(t)) is the covariance of S(t) and U(t) and σ_{S} and σ_{U} are the standard deviations of S(t) and U(t).

For a limited number of noise indicators the correlation coefficient is the expressed by:

$$C = \frac{\frac{1}{N} {Σ}_{i = 1}^{N} ( {s}_{i} - \overline{s} ) ( {u}_{i} - \overline{u} )}{{σ}_{s} {σ}_{u}} .$$

where sᵢ represents the amplitude of the i′th noise indicator and s is the mean value of sᵢ and σ_{U} the standard deviation of sᵢ. Correspondingly ū is the mean value of uᵢ and σᵤ is the standard deviation of uᵢ.

By applying the unity step function U(t) the value of ū=0 and the value of σᵤ=1. When inserted in the equation above this leads to the following simplification:

$$C = \frac{{Σ}_{i = \frac{N}{2} + 1}^{N} {s}_{i} - {Σ}_{i = 1}^{\frac{N}{2}} {s}_{i}}{N {σ}_{s}} = \frac{{Σ}_{i = N / 2 + 1}^{N} {s}_{i} - {Σ}_{i = 1}^{N / 2} {s}_{i}}{\sqrt{N {{Σ}_{i = 1}^{N} ( {s}_{i} - \overline{s} )}^{2}}} .$$

The left hand side of the numerator can be interpreted as the situation after the change of fluid pressure whereas the right hand side represents the situation before.

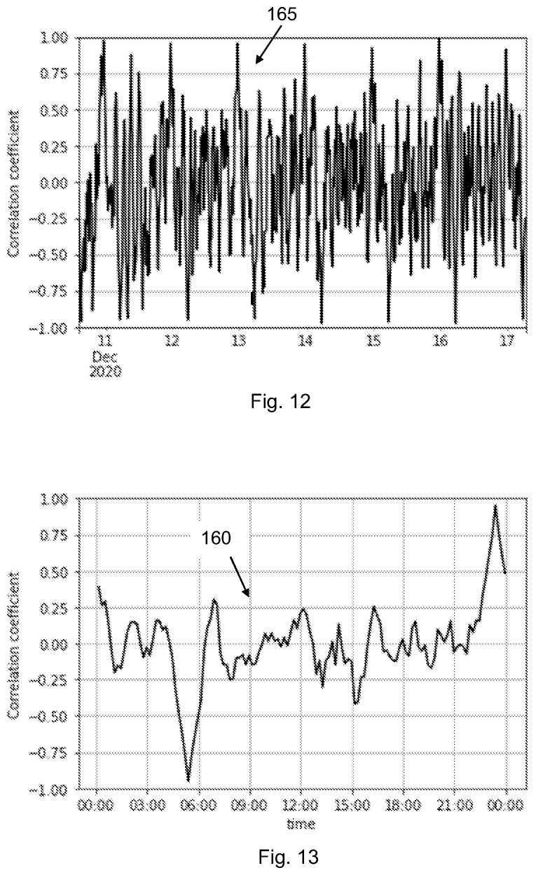

Referring now to FIGS. 12 and 13 a concept of averaging the correlation coefficient will be described. In FIG. 12 reference number 165 indicate the development of the correlation coefficient calculated during one full week. Noise indicators before and after a time of pressure change in the pipes have been established and a correlation coefficient has been calculated for a time window of 2 hours around each measurement. As seen in the figure high correlation spikes of for example C>0.75 appear but such high values—normally not related to a leak indication—blurs the picture. They are caused by random correlations due to natural variations in the pipe environment. However, by averaging the window correlations over time a calmed and less blurred correlation curve can be obtained as shown in FIG. 13. The curve shows average correlation coefficient 160 and represents the development of the average coefficient over 24 hours. The curve is based on the data from FIG. 12, and, as an example, all correlation coefficients calculated in a time window placed at 12 o'clock each day during the preceding week are summed and then averaged and plotted into FIG. 13. Thus, for example, the average correlation coefficient for the preceding week at 12 o'clock is 0.25. As the SCADA system has introduced night savings there is, as expected, large correlations just before 6 o'clock and 24 o'clock (shown as 00:00 in the figure). This calculation of an average correlation coefficient can in principle be performed by the acoustic sensor, and the largest correlation can be time stamped and sent to the back-end system.

In one embodiment of the method for identifying leak indication, the first noise indicators from a plurality of acoustic sensors of a pipe network are compared to a predetermined noise threshold. If the first noise indicator determined is above the noise threshold the noise level is considered abnormal which may be a first indication of a leak indication. If the first noise indicator is below the noise threshold the noise level is considered normal.

As described above, the noise indicator could be a single noise number indicating the noise at the site, such as a peak value or a RMS-value, however it could also be more advanced with specific frequencies weighed and taken into account. It can also be raw, unprocessed data. The noise indicator may be based on the latest noise measurements or include historical noise measurements from the previous day, wee, month or year.

FIG. 9 illustrates a pipe sub-system 21 subject to a changed i.e. lower pressure (right hand side figure) and a normal i.e. higher pressure (left hand side figure), respectively. The pipe sub-system includes a number of acoustic sensors (illustrated by the small dots) and whether the level of noise power measured by each acoustic sensor is normal or abnormal is illustrated by the size of the dot 92. As seen from the figures the left hand side figure has five acoustic sensors provided with an abnormal noise level indication 92 and the right hand side figure has only three provided with an abnormal noise level indication 92. Following the reduction in pressure from the one scenario to the other, the noise indicator determined by two acoustic sensors have thus changed indicating a correlation between the noise power and system pressure at these installations. As described above, this may be an indication of a leak.

The embodiments of the invention described may be combined in different ways.

### REFERENCE NUMBERS

1 Utility distribution system
3 Service connections
4 Pressure controlling devices
5 Acoustic sensors
6 Back-end system
7 Pressure sensing device
8 Data collection system
21 Pipe sub-networks
51 Period of normal fluid pressure
52 Period of changed fluid pressure
55 Time of change of fluid pressure
60, 61 First noise indicator
62, 63 Second noise indicator
92 Dot indicating noise level
100 Method for identifying leak indications
101 Mobile reading device
110 Determining the presence of normal fluid pressure
120 Establishing first noise indicator during normal fluid pressure
130 Determining the presence of a changed fluid pressure
140 Establishing a second noise indicator
150 Correlation of first noise indicators, second noise indicators and fluid pressure
155 Time window
156 Time window
160 Average correlation coefficient
165 Correlation coefficients per window over time
200 AMI-installed infra structure

1. A method for identifying a leak indication in a utility distribution system having
a pipe network for supplying a utility to a multitude of service connections, and
a plurality of acoustic sensors mounted at the service connections, for measuring noise in the pipes, said method comprising:
implementing a pressure variation profile at regular intervals;
obtaining information about a time of change of a fluid pressure during zero flow or low flow in the pipes by
establishing a first noise indicator from a noise measured before said time of change, and
establishing a second noise indicator from a noise measured after said time of change; and
correlating one or more of the first noise indicators and the second noise indicators with the fluid pressure to identify service connections subject to leak indications.

2. The method according to claim 1 wherein the information about the time of change of the fluid pressure is provided as a signal from one or more of the following signal providers: a pressure sensing device in the pipe network, a pressure sensor integrated in the acoustic sensor or a pressure sensor in a pressure controlling device, such as in a pump.

3. The method according to claim 1 wherein the information about the time of change of the fluid pressure is provided by a utility provider, and wherein the information concerns either historical, actual or planned time of change of fluid pressure, or simply information indicating that the fluid pressure has changed.

4. The method according to claim 1, wherein each of the first noise indicators or the second noise indicators are time stamped at the time of measurement, and that the first noise indicators or the second noise indicators with a time stamp close to the time of change of fluid pressure are selected for correlation whereas first noise indicators or second noise indicators with time stamps earlier or later than the selected indicators are not selected for correlation.

5. The method according to claim 4 wherein only first noise indicators or second noise indicators with a time stamp falling within time limits of a time window are used for the correlation, and wherein the time of change is in-between the time limits.

6. The method according to claim 5 wherein the time window is in the range of 24 hours to 12 hours, more preferred in the range of 11 hours to 5 hours and most preferred in the range of 4 hours to 5 hours.

7. The method according to claim 1 wherein an average correlation coefficient is calculated from correlation coefficients calculated in a plurality of time windows, wherein said correlation coefficient are between the fluid pressure and the one or more first and second noise indicators, whereafter said average correlation coefficient is used to identify service connections subject to leak indications.

8. The method according to claim 1 wherein the fluid pressure is represented by a unity step function which is correlated with the one or more first and second noise indicators.

9. The method according to claim 1 wherein receiving and storing the one or more first and second noise indicators, obtaining information about the time of change of fluid pressure and then performing the correlation is done in a back-end system.

10. The method according to claim 1 wherein establishing the first noise indicator, establishing the second noise indicator, obtaining information about a time of change of fluid pressure, and performing the correlation is done by the acoustic sensor, such as an ultrasonic flow meter including an acoustic sensor.

11. The method according to claim 1 wherein a service connection is identified as subject to leak indications if a correlation coefficient between the fluid pressure and the one or more first and second noise indicators is above a predetermined threshold, preferably above 0.4.

12. The method according to claim 1 further comprising the step of actively inducing the change in fluid pressure in the utility distribution system or in a part of the utility distribution system, such as by operating one or more pressure controlling devices arranged through-out the pipe network.

13. The method according to claim 1 wherein the acoustic sensor measures the noise in the pipe by sampling, and a sampling frequency is increased during a period of changed fluid pressure in the utility distribution system or in a part of the utility distribution system.

14. The method according to claim 1 wherein the acoustic sensors are included in consumption utility meters having radio communication capability of the first noise indicators and second noise indicators, such as ultrasonic flow meters mounted at the service connections.

15. The method according to claim 14 wherein a plurality of ultrasonic flow meters, such as in the range of 50 to 10,000 flow meters, sample the noise signal at a time which is synchronized with the pressure controlling device lowering or increasing the fluid pressure in the pipe network.

16. A leak detection system for identifying leak indication in a utility distribution system which includes a pipe network for supplying a utility to a multitude of service connections and a plurality of acoustic sensors mounted at the service connections, wherein the leak detection system comprises:
a plurality of acoustic sensors configured to establish one or more first noise indicators and second noise indictors,
a back-end system for receiving the one or more first noise indicators and second noise indicators from the plurality of acoustic sensors;
pressure controlling devices controlled to generate fluid pressure changes such that the pressure in the distribution system is reduced during night time; and
a signal provider providing a signal to the back-end system about a change in fluid pressure;
wherein said back-end system is configured for correlating the fluid pressure with the one or more first noise indicators established before the change in fluid pressure and the one or more second noise indicators established after the change in fluid pressure in order to identify service connections subject to leak indications.

17. (canceled)

18. (canceled)

19. A leak detection system according to claim 16 wherein the one or more pressure controlling devices is a speed regulated pump in communication with the head-end system or in communication with the one or more of the acoustic sensors and where the pressure controlling device reduces the fluid pressure in the pipe network or stops pumping if an indication of leakage has been established.

20. A leak detection system according to claim 16 wherein the acoustic sensors are integrated as a part of an ultrasonic flow meter, the ultrasonic flow meter adds a time stamp to the one or more first noise indicators and second noise indicators and transmits the time stamped indicators by radio communication through a data collection system to the back-end system.

21. The method according to claim 1 wherein the pressure changes are in the range of 75% to 125% of the normal operation fluid pressure, or such as 50%-150%, or 25%-175% or 0%-200%.
